(19) United States
(12) Patent Application Publication
(10) Pub. No.: US 2010/0150084 A1
(43) Pub. Date: Jun. 17, 2010

(54) Radio Base Station and Radio Communication Method

(75) Inventors: Shingo Joko, Yokohama (JP); Takeshi Toda, Yokohama (JP); Taku Nakayama, Yokohama (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/528,302

(22) PCT Filed: Feb. 20, 2008
(86) PCT No.: PCT/JP2008/052891

§ 371 Date: Feb. 23, 2010

(30) Foreign Application Priority Data
Feb. 23, 2007 (JP) 2007-044435

(51) Int. Cl. H04W 4/00

(52) U.S. Cl. 370/329

(57) ABSTRACT

A radio base station (100A) transmits channel allocation information to a radio communication terminal by using a downward frame containing a map region which is broadcast by a non-directivity beam and a particular region transmitted toward a predetermined direction by a directivity beam. The radio base station (100A) includes: a traffic state acquisition unit (105) which acquires the traffic state handled by a mobile communication system (1); and a frame control unit (107) which changes the size of the particular region in the downward frame according to the traffic state obtained by the traffic state acquisition unit (105).

### TECHNICAL FIELD

The present invention relates to a radio base station and a mobile communication method for transmitting channel allocation information to a radio communication terminal by using a downlink frame including a map region broadcasted by a non-directional beam, and a specific region transmitted in a predetermined direction by a directional beam, the channel allocation information indicating allocation of radio communication channels.

### BACKGROUND ART

In recent years, a mobile communication system capable of achieving high-speed communications by using orthogonal frequency-division multiplexing (OFDM) has been put to practical use. For example, Mobile WiMax defined in IEEE 802.16e is known as such a mobile communication system.

In Mobile WiMax, a radio communication terminal receives channel allocation information (DL-MAP and a UL-MAP) broadcasted from a radio base station by a non-directional beam.

Additionally, when the radio communication terminal cannot receive channel allocation information transmitted in a map region in a downlink frame, for example, when the radio communication terminal cannot receive the channel allocation information because of being far from the radio base station, the radio communication terminal can acquire the channel allocation information by referring to a specific region in the downlink frame, specifically, AAS-DLFP (adaptive antenna system-downlink frame prefix) (refer to Non-patent Document 1). The AAS-DLFP (an AAS pointer) is transmitted from a radio base station in a predetermined direction by a directional beam by use of an array antenna.
Non-patent Document 1; “IEEE 802.16e-2005,” [online], February 2006, [retrieved on Jan. 24, 2007], Internet URL: http://standards.ieee.org/getieee002/download/802.16e-2000.pdf

### DISCLOSURE OF THE INVENTION

However, the above described conventional method of channel allocation information acquisition involves the following problem. That is, the radio base station cannot recognize whether or not the radio communication terminal can receive the channel allocation information, and therefore, has to transmit the channel allocation information by using the channel allocation information broadcasted by a non-directional beam, and also by using the AAS-DLFP transmitted in a predetermined direction by a directional beam. This causes a problem that the allocatable region, for user data, in a downlink frame decreases, that is, efficiency in the use of the downlink frame is deteriorated.

In this respect, the present invention has been made in consideration of the above described situation, and aims to provide a radio base station and mobile communication method which improve efficiency in the use of a downlink frame, and at the same time allow a radio communication terminal to more reliably acquire channel allocation information.

The present invention has the following characteristics to solve the problems described above. First of all, a first characteristic of the present invention is summarized as a radio base station (for example, radio base station 100A) configured to transmit, to a radio communication terminal (radio communication terminal 200A to 200C), channel allocation information (for example, DL-MAP) indicating allocation of a radio communication channel (sub channel CH_{S}) by using a downlink frame (downlink frame F_{DL}) containing a map region (region A1) broadcasted by a non-directional beam and a specific region (region A20) transmitted in a predetermined direction by a directional beam. The radio base station includes: a traffic state acquisition unit (traffic state acquisition unit 105) configured to acquire a traffic state between the radio communication terminal and the radio base station; and a frame controller (frame controller 107) configured to change a size of the specific region in the downlink frame on the basis of the traffic state acquired by the traffic state acquisition unit.

According to the radio base station as described above, a size of a specific region in a downlink frame changes in accordance with a traffic state between a radio communication terminal and the radio base station. That is, when traffic between the radio communication terminal and the radio base station is low, the size of the specific region is increased, whereby the number of times channel allocation information is transmitted can be increased.

Thereby, the radio communication terminal can more reliably acquire the channel allocation information.

On the other hand, when traffic between a radio communication terminal and the radio base station is high, a size of the specific region can be decreased. Consequently, efficiency in the use of the downlink frame can be improved.

A second characteristic of the present invention is according to the first characteristic of the present invention, and is summarized in that the frame controller increases the size of the specific region when an amount of the traffic is lower than a predetermined threshold value.

A third characteristic of the present invention is according to the first characteristic of the present invention, and is summarized in that the traffic state acquisition unit acquires information as to whether or not an unused radio communication channel (sub-channel CH_{S}) in downlink exists, and the frame controller increases the size of the specific region when the traffic state acquisition unit acquires information that the unused radio communication channel exists.

A fourth characteristic of the present invention is according to the first characteristic of the present invention, and is summarized in that the radio base station further includes a transmission controller (transmission controller 109) configured to control a transmission power of a radio signal (radio signal S) containing the downlink frame, wherein the transmission controller changes the transmission power of the radio signal in transmission of the specific region on the basis of the traffic state acquired by the traffic state acquisition unit.

A fifth characteristic of the present invention is according to the fourth characteristic of the present invention, and is summarized in that the frame controller changes the size of the specific region so that a product obtained by multiplying a frequency band width occupied by the radio signal in transmission of the specific region by a power density of the transmission power of the radio signal in transmission of the specific region may fall within a predetermined range.

A sixth characteristic of the present invention is according to the fourth characteristic of the present invention, and is summarized in that the transmission controller changes the transmission power so that a product obtained by multiplying a frequency band width occupied by the radio signal in transmission of the specific region by a power density of the transmission power of the radio signal in transmission of the specific region may fall within a predetermined range.

A seventh characteristic of the present invention is according to the fourth characteristic of the present invention, and is summarized in that a position of the specific region in the downlink frame is different from one radio base station to another included in a mobile communication system, and when a neighboring radio base station is transmitting and receiving user data in the position of the specific region, the transmission controller transmits the radio signal in a direction other than a direction toward the neighboring radio base station.

A eighth characteristic of the present invention is according to the fourth characteristic of the present invention, and is summarized in that a position of the specific region in the downlink frame is the same as the position of the specific region in the downlink frame of a neighboring radio base station, and when the neighboring radio base station is transmitting and receiving the radio signal in the position of the specific region, the transmission controller transmits the radio signal toward the neighboring radio base station.

A ninth characteristic of the present invention is summarized as a radio communication method for transmitting, to a radio communication terminal, channel allocation information which indicates allocation of a radio communication channel by using a downlink frame containing a map region broadcasted by a non-directional beam, and a specific region transmitted in a predetermined direction by a directional beam. The radio communication method includes: acquiring a traffic state between the radio communication terminal and the radio base station; and changing a size of the specific region in the downlink frame on the basis of the traffic state acquired.

According to the characteristics of the present invention, a radio base station and a mobile communication method which improve efficiency in the use of a downlink frame and at the same time allow a radio communication terminal to more reliably acquire channel allocation information can be provided.

### BRIEF DESCRIPTION OF THE DRAWINGS

FIG. 1 is an overall schematic configuration diagram of a mobile communication system according to an embodiment of the present invention.

FIG. 2 is a functional block diagram of a radio base station according to the embodiment or the present invention.

FIG. 3 is an operational flowchart of the radio base station according to the embodiment of the present invention.

FIG. 4 is a diagram showing one example of a frame structure used in the embodiment of the present invention.

FIG. 5 is a diagram showing another example of a frame structure used in the embodiment of the present invention.

### BEST MODE FOR CARRYING OUT THE INVENTION

Next, an embodiment of the present invention will be described. Note that, in the following description of the drawings, the same or like reference numerals are given to the same or like parts. However, it should be noted that, since the drawings are schematic, dimensional proportions and the like are different from actual ones.

Accordingly, specific dimensions and the like should be judged in consideration of the following description. Additionally, it goes without saying that there are some parts having dimensional relationships and dimensional proportions different from one drawing to another.

(Overall Schematic Configuration of Mobile Communication System)

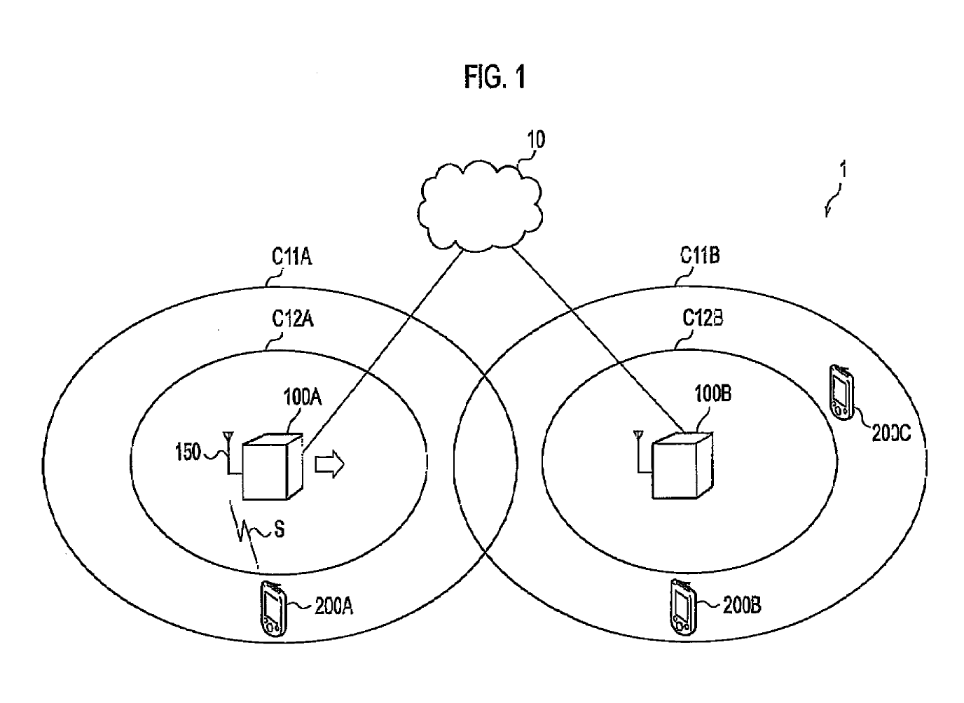

FIG. 1 is an overall schematic configuration diagram of a mobile communication system 1 according to this embodiment. As shown in FIG. 1, the mobile communication system 1 is composed of a backbone network 10, radio base stations 100A and 100B and radio communication terminals 200A to 200C.

The mobile communication system 1 conforms to Mobile WiMax defined in IEEE 802.16e. That is, the radio base stations 100A and 100B and the radio communication terminals 200A to 200C transmit and receive radio signals S complying with orthogonal frequency-division multiplexing (OFDM).

The radio base station 100A includes an array antenna 150, thereby being capable of transmitting the radio signal S by using a directional beam. Additionally, the radio base station 100A is also capable of transmitting the radio signal S by using a non-directional beam.

The radio signal S for which a non-directional beam is used reaches a radio communication terminal located inside a cell C12A. The radio signal S for which a directional beam is used is subjected to beam-forming, and therefore reaches a further location than the radio signal S for which a non-directional beam is used, specifically, reaches a radio communication terminal located inside a cell C11A.

The radio base station 100B has the same configuration as the radio base station 100A. The radio base station 100B forms a cell C11B by the radio signal S for which a directional beam is used, and forms a cell C12B by the radio signal S for which a non-directional beam is used.

Each of the radio communication terminals 200A to 200C transmits and receives the radio signal S between itself and each of the radio base stations 100A and 100D. Each of the radio communication terminals 200A to 200C is a portable compact terminal, and is equipped with a voice communication function and data communication functions (such as e-mail and FTP).

(Functional Block Configuration of Radio Base Station)

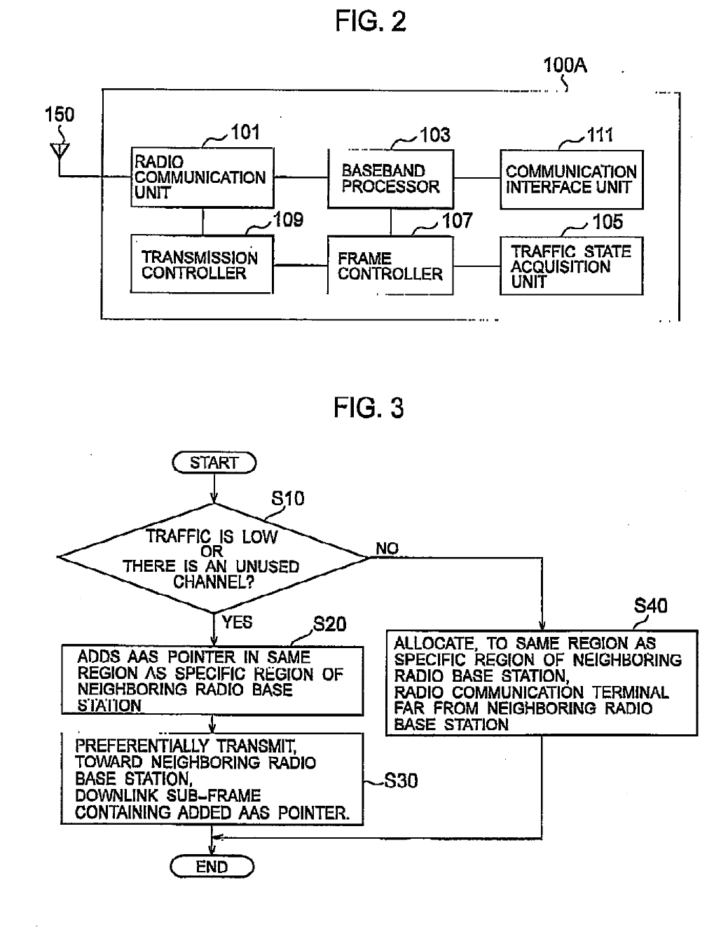

FIG. 2 is a functional block diagram of the radio base station 100A. Note that the radio base station 100B also has the same functional block configuration as the radio base station 100A.

As shown in FIG. 2, the radio base station 100A includes a radio communication unit 101, a baseband processor 103, a traffic state acquisition unit 105, a frame controller 107, a transmission controller 109 and a communication interface unit 111.

Note that parts relating to the present invention will be mainly described below. Accordingly, it should be noted that, in some cases, the radio base station 100A may include a block (such as a power source unit) which is not illustrated or for which description is omitted, the block being essential for the radio base station 100A to implement functions as the radio base station 100A.

The radio communication unit 101 transmits and receives the radio signals S in a predetermined frequency band (for example, a 2.5 GHz band) by using an array antenna 150. Specifically, the radio communication unit 101 can form either a directional beam or a non-directional beam by using the array antenna 150.

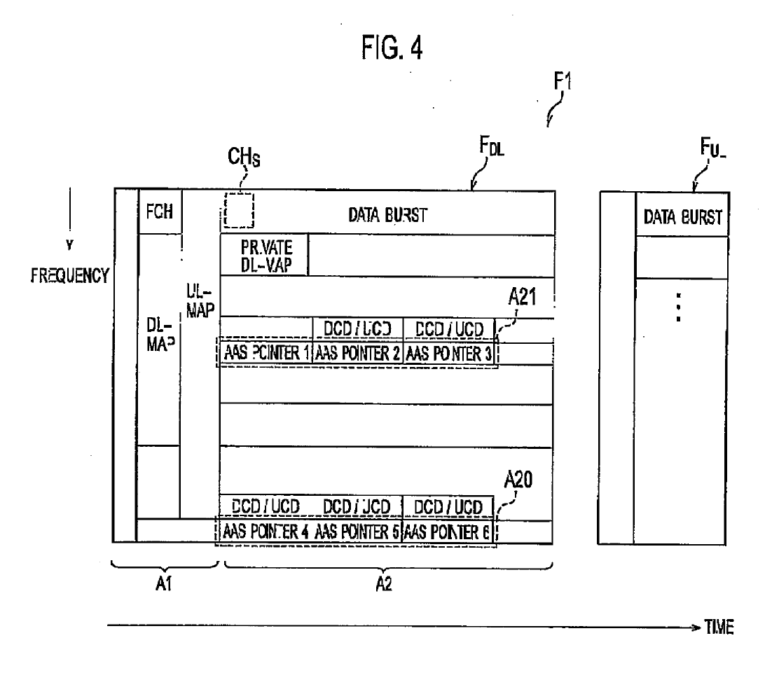

In this embodiment, each of the radio signals S has a frame structure as shown in FIG. 4. Note that a specific structure of a frame F1 shown in FIG. 4 will be described later.

The baseband processor 103 is connected to the radio communication unit 101. The baseband processor 103 serves: to transmit data, specifically, baseband signals of user data, control data and the like, to the radio communication unit 101; to demodulate the radio signal S that has been received from the communication unit 101; and the like.

The traffic state acquisition unit 105 acquires a traffic state between the radio communication terminal 200A (or 200B or 200C) and the radio base station 100A. Specifically, the traffic state acquisition unit 105 acquires information (for example, an amount of IP packets transmitted and received in a predetermined time period) indicating an amount of traffic between the radio communication terminal 200A (or 200B or 200C) and the radio base station 100A.

Note that the traffic state acquisition unit 105 may acquire a state of traffic handled by the mobile communication system 1. For example, the traffic state acquisition unit 105 acquires information, through the backbone network 10, from a radio control apparatus (unillustrated) that controls a radio base station placed in a predetermined area, the information indicating a state of traffic handled by the radio base station 100A and a neighboring radio base station (the radio base station 100B).

Additionally, in this embodiment, the traffic state acquisition unit 105 is capable of acquiring information as to whether or not there is any radio communication channel, specifically, any sub-channel CH_{S} (unillustrated in FIG. 2, refer to FIG. 4), being unused in downlink. As shown in FIG. 4, a sub-channel CH_{S} is defined by combination of a frequency and a time (timing).

The frame controller 107 controls a structure of the frame F1. As shown in FIG. 4, the frame F1 is composed of a downlink sub-frame F_{DL} and an uplink sub-frame F_{DL}.

The downlink sub-frame F_{DL} includes a region A1 in which a DL-MAP and an UL-MAP are transmitted, the DL MAP and UL-MAP being allocation information (channel allocation information) on downlink sub-channels CH_{S} and allocation information (channel allocation information) on uplink sub-channels CH_{S}, respectively, in the region A1, a UCD (uplink channel descriptor) message defining characteristics of the uplink sub channels CH_{S} and a DCD (downlink channel descriptor) message defining characteristics of the downlink sub-channels CH_{S} are also transmitted. The region A1 (a map region) is broadcasted to radio communication terminals by use of a non-directional beam, the radio communication terminals being located inside the cell C12A.

Furthermore, the downlink sub-frame F_{DL} includes a region A2 in which a data burst containing user data and the like is transmitted. The region A2 is transmitted not omnidirectionally but in a predetermined direction by use of a directional beam. Additionally, a region A20 (a specific region) in which AAS pointers 1 to 3 (AAS-DLFP) are transmitted is provided in the region A2.

Each of the AAS pointers 1 Lo 3 is set pointing to the UCD message, the DCD message or a private DL-MAP. The respective AAS pointers 1 to 3 are transmitted by directional beam patterns different from one another, that is, in directions different from one another.

Moreover, in this embodiment, a location of a specific region in which AAS pointers are transmitted is different by radio base station included in the mobile communication system 1. Specifically, the region A20 is allocated as a specific region to the radio base station 100A, and a region A21 is allocated as another specific region to the radio base station 100B.

The frame controller 107 changes a size of the region A20 in a downlink frame on the basis of the traffic state acquired by the traffic state acquisition unit 105. Specifically, when an amount of traffic (IP packets) which is acquired by the traffic state acquisition unit 105 is lower than a predetermined threshold value, the frame controller 107 increases the size of the region A20.

Additionally, the frame controller 107 can increase the size of the region A20 also when the traffic state acquisition unit 105 acquires information that there is any unused sub-channel CH_{S}.

Furthermore, in this embodiment, the frame controller 107 changes the size of the region A20 so that a product may fall within a predetermined range, the product being obtained by multiplying: a frequency band width occupied by the radio signal S in transmission of the region A20; by a power density of a transmission power of the radio signal S in transmission of the region A20.

Specifically, the frame controller 107 is capable of: heightening the power density of the radio signal S in accordance with the traffic acquired by the traffic state acquisition unit 105 and with a state or use of the sub-channels CH_{S}, that is, heightening the power density of the radio signal S on condition that the size of the region A20 is constant; or, although this is applicable to limited traveling distances, lowering the power density of the radio signal S so as to increase the size of the region A20 on condition that the transmission power of the radio signal S is constant.

The transmission controller 109 controls the transmission power of the radio signal S. In this embodiment, the transmission controller 109 changes the transmission power of the radio signals S in transmission of the region A20 on the basis of the traffic state acquired by the traffic state acquisition unit 105.

Specifically, when the amount of traffic (IP packets) acquired by the traffic state acquisition unit 105 is lower than a predetermined threshold value, the transmission controller 109 increases the transmission power of the radio signal S.

Additionally, the transmission controller 109 is capable of increasing the transmission power of the radio signal S also when the traffic state acquisition unit 105 acquires information that there is any unused sub-channel CH_{S}.

Furthermore, in this embodiment, the transmission controller 109 changes the transmission power so that a product may fall within a predetermined range, the product being obtained by multiplying: the frequency band width occupied by the radio signal S used in transmission of the region A20; by the power density of the transmission power of the radio signal S in transmission of the region A20.

Specifically, the transmission controller 109 sets a value as a power usable for transmitting the region A20, the value being obtained by subtracting, from the maximum transmission power, a power required for transmitting user data.

Additionally, the transmission controller 109 can transmit the radio signal S by using a beam, whose coverage is narrower, when the number of AAS pointers is larger, that is, when the size of the region A20 is larger; and by using a beam, whose coverage is wider, when the number of AAS pointers is smaller.

Additionally, the transmission controller 109 transmits the radio signal S in a direction other than a direction toward the radio base station 100B when the radio base station 100B (the neighboring radio base station) is transmitting and receiving radio signals S in a position of the region A20. Specifically, when the radio base station 100B is transmitting and receiving user data in the position of the region A20, the transmission controller 109 controls so as to divert the directional beam from a direction toward the radio base station 100B (in an arrow direction in FIG. 1) for the purpose of avoiding interference of the user data.

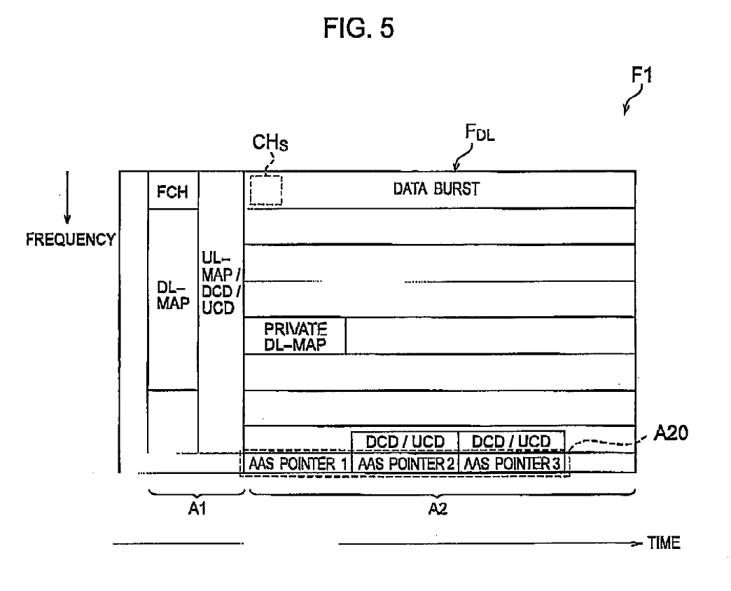

Note that, as shown in FIG. 5, the radio base station 100A and the radio base station 100B may have a common position for the specific regions in the downlink sub-frame F_{DL}. In that case, the transmission controller 109 transmits the radio signal S toward the radio base station 100B when the radio base station 100B is transmitting and receiving radio signals S in the position of the region A20.

The communication interface unit 111 provides a communication interface required for connection to the backbone network 10. Note that a management apparatus, which manages information on traffic handled by the mobile communication system 1, and the like are connected to the backbone network 10.

(Operations of Mobile Communication System)

Next, operations of the above described mobile communication system 1 will be described with reference to FIG. 3. Specifically, there will be described: an operation in which the radio base station 100A changes the size of the region A20 (the specific region); and an operation in which the radio base station 100B allocates a sub-channel CH_{S} to a radio communication terminal while avoiding interference of the radio signals S being transmitted and received by the radio base station 100B.

As shown in FIG. 3, in step S10, the radio base station 100A determines whether or not traffic (IP packet amount) handled by the mobile communication system 1 is low or whether or not there is any unused sub-channel CH_{S} in downlink.

If the traffic (IP packet amount) handled by the mobile communication system 1 is low or if there is a sub-channel CH_{S} being unused in downlink (YES in step 10), in step S20 the radio base station 100A adds an AAS pointer (AAS DLFP) in the same region as a specific region used by a neighboring radio base station, specifically, the radio base station 100B. That is, the radio base station 100A increases a size of the region A20 in a downlink sub-frame F_{DL} (refer to FIG. 4).

In step S30, the radio base station 100A transmits the downlink sub frame F_{DL}, which contains the added ASS pointer, preferentially toward the radio base station 100B.

If the traffic (IP packet amount) handled by the mobile communication system 1 exceeds a predetermined threshold value or if there is no unused sub-channel CH_{S} in downlink (NO in step 10), in step S40 the radio base station 100A allocates a radio communication terminal to the same region as the specific region used by the radio base station 100B, the radio communication terminal being far from the radio base station 100B. That is, the radio base station 100A allocates the radio communication terminal to the sub-channel CH_{S} corresponding to the region, the radio communication terminal being far from the radio base station 100B.

(Functions and Effects)

According to the radio base station 100A, a size of the region A20 (the specific region) in the downlink sub-frame F_{DL} changes in accordance with a traffic state between the radio communication terminal 200A (or 200B or 200C) and the radio base station 100A. That is, when traffic between the radio communication terminal 200A (or 200B or 200C) and the radio base station 100A is low, the size of the specific region is increased, whereby the number of times channel allocation information (for example, DL-MAP) is transmitted can be increased. Consequently, the radio communication terminal 200A (or 200B or 200C) can more reliably acquire the channel allocation information.

On the other hand, when traffic between the radio communication terminal 200A (or 200B or 200C) and the radio base station 100A is high, the size of the specific region can be decreased. Consequently, efficiency in the use of the downlink sub-frame F_{DL} can be improved.

In this embodiment, a transmission power of the radio signal S in transmission of the specific region can be changed on the basis of the traffic state acquired by the traffic state acquisition unit 105. Additionally, in this embodiment, the size of the specific region and the transmission power of the radio signal S can be changed so that a product obtained by multiplying a frequency band width occupied by the radio signal S in transmission of the specific region by a power density of the transmission power of the radio signal S in transmission of the specific region may fall within a predetermined range.

Furthermore, in this embodiment, the radio base station 100A transmits the radio signal S in a direction other than a direction toward the radio base station 100B when the neighboring radio base station 100B is transmitting and receiving user data in the position of the specific region used by the radio base station 100A.

Consequently, the radio base station 100A suppresses interference thereof with the neighboring radio base station 100B to the minimum extent possible, and at the same time allows the radio communication terminal 200A (or 200B or 200C) to more reliably acquire the channel allocation information.

### Other Embodiments

Although contents of the present invention have been disclosed by way of one embodiment of the present invention as has been described hereinabove, it should not be understood that any statement or any drawing composing a part of this disclosure limits the present invention. Various alternative embodiments will be apparent to those skilled in the art in accordance with this disclosure.

For example, when the neighboring radio base station 100B is transmitting and receiving user data in the position of the specific region used by the radio base station 100A, the radio base station 100A is not necessarily required to transmit the radio signal S in a direction other than a direction toward the radio base station 100B although being configured to transmit the radio signal S in a direction other than a direction toward the radio base station 100B in the above described embodiment.

Although being configured to be changed based on a state of traffic handled by the mobile communication system 1 in the above described embodiment, a transmission power of the radio signal S in transmission of the specific region is not necessarily required to be changed.

As described above, it goes without saying that the present invention includes various embodiments and the like which are not described herein. Accordingly, the technical scope of the present invention is only defined by the specific subject matters of the invention according to the scope of the invention as defined by the appended claims appropriate for this disclosure.

Note that entire contents of Japanese Patent Application No. 2007-044435 (filed on Feb. 23, 2007) are incorporated by reference in the description of the present application.

### INDUSTRIAL APPLICABILITY

The radio base station and radio communication method according to the present invention are beneficial in radio communications such as mobile communications since, as has been described above, the radio base station and radio communication method improve efficiency in the use of a downlink frame and at the same time allow a radio communication terminal to more reliably acquire channel allocation information.

1. A radio base station configured to transmit, to a radio communication terminal, channel allocation information indicating allocation of a radio communication channel by using a downlink frame containing a map region broadcasted by a non-directional beam and a specific region transmitted in a predetermined direction by a directional beam, the radio base station comprising:
a traffic state acquisition unit configured to acquire a traffic state between the radio communication terminal and the radio base station; and
a frame controller configured to change a size of the specific region in the downlink frame on the basis of the traffic state acquired by the traffic state acquisition unit.

2. The radio base station according to claim 1, wherein the frame controller increases the size of the specific region when an amount of traffic is lower than a predetermined threshold value.

3. The radio base station according to claim 1, wherein
the traffic state acquisition unit acquires information as to whether or not an unused radio communication channel in downlink exists, and
the frame controller increases the size of the specific region when the traffic state acquisition unit acquires information that the unused radio communication channel exists.

4. The radio base station according to claim 1 further comprising a transmission controller configured to control a transmission power of a radio signal containing the downlink frame, wherein
the transmission controller changes the transmission power of the radio signal in transmission of the specific region on the a basis of the traffic state acquired by the traffic state acquisition unit.

5. The radio base station according to claim 4, wherein the frame controller changes the size of the specific region so that a product obtained by multiplying a frequency band width occupied by the radio signal in transmission of the specific region by a power density of the transmission power of the radio signal in transmission of the specific region may fall within a predetermined range.

6. The radio base station according to claim 4, wherein the transmission controller changes the transmission power so that a product obtained by multiplying a frequency band width occupied by the radio signal in transmission of the specific region by a a power density of the transmission power of the radio signal in transmission of the specific region may fall within a predetermined range.

7. The radio base station according to claim 4, wherein
a position of the specific region in the downlink frame is different from one radio base station to another included in a mobile communication system, and
when a neighboring radio base station is transmitting and receiving user data in the position of the specific region, the transmission controller transmits the radio signal in a direction other than a direction toward the neighboring radio base station.

8. The radio base station according to claim 4, wherein
a position of the specific region in the downlink frame is the same as the position of the specific region in the downlink frame of a neighboring radio base station, and
when the neighboring radio base station is transmitting and receiving the radio signal in the position of the specific region, the transmission controller transmits the radio signal toward the neighboring radio base station.

9. A radio communication method tor transmitting, to a radio communication terminal, channel allocation information which indicates allocation of a radio communication channel by using a downlink frame containing a map region broadcasted by a non-directional beam, and a specific region transmitted in a predetermined direction by a directional beam, the method comprising:
acquiring a traffic state between the radio communication terminal and the radio base station; and
changing a size of the specific region in the downlink frame on the basis of the traffic state acquired.
